(19) United States
(12) Patent Application Publication
(10) Pub. No.: US 2012/0167831 A1
(43) Pub. Date: Jul. 5, 2012

(54) EAR TAG

(76) Inventors: Clinton Simpson, Whitfield (AU); Kevin Teague, Katandra West (AU)

(21) Appl. No.: 13/395,431

(22) PCT Filed: Sep. 10, 2010
(86) PCT No.: PCT/AU2010/001173

§ 371 Date: Mar. 9, 2012

(30) Foreign Application Priority Data
Sep. 11, 2009 (AU) 2009904438

(51) Int. Cl. A61D 99/00; A01K 11/00; A01K 29/00

(52) U.S. Cl. 119/651; 119/655

(57) ABSTRACT

An ear tag for preventing or treating an infection of an eye of an animal, the ear tag comprising a length of material and being arranged to be coupled to an ear of the animal, the length of material being flaccid so as to swing freely about the coupling so that movement of the ear causes the length of material to flap on or near the eye.

### FIELD OF THE INVENTION

The present invention relates to an ear tag. More particularly, but not exclusively, the invention relates to an ear tag for preventing or treating an infection of an eye of an animal.

### BACKGROUND OF THE INVENTION

Ocular infections, for example those associated with diseases such as pink eye (infectious keratoconjunctivitis) caused by the Moraxella bovis bacterium and other organisms, commonly affects animals such as cows. It is believed that Moraxella bovis bacterium clings to the cornea, producing toxins and haemolysins which can lead to infection of the eye. Eye infections can also arise from foreign matter, such as grass seeds for example, becoming lodged under an animal's eyelid.

Ocular infections can cause inflammation and irritation of an animal's eye and have other detrimental effects to an animal's health. For example, cows affected by pink eye can suffer from decreased weight gain and milk production and, due to vision loss, can inadvertently wander into dangerous situations and become injured. Pink eye can also increase the susceptibility of the eye to cancer. Treatment of such infections, by way of ointments or eye patches for example, can be expensive and whilst treatment may reduce the spread of the infection throughout a herd, it generally has little preventative effect for future infections.

Bacteria associated with infections, especially the bacterium which causes pink eye, can be spread by flies and can spread amongst a herd of cattle in a short period of time. Whilst it has been proposed to vaccinate cows annually, the cost can be prohibitive.

It has been previously proposed, in documents such as U.S. Pat. No. 3,935,839 and U.S. Pat. No. 4,579,085, to suspend a device impregnated with insecticide or pesticide from an animal's ear to repel insects. Such devices can be expensive to purchase due to the chemicals used and also to maintain as they require attention to ensure that the insecticide or pesticide is replenished. Due to the shape of previous devices, which are generally band-like, their degree of freedom for movement is limited, thus restricting their ability to apply the insecticide or pesticide to the animal evenly.

Furthermore, due to the liquid form of the insecticide or pesticide, these devices can also be heavy and may cause damage to an animal's ear. Also, depending on the type of insecticide or pesticide used, meat withholding periods or milk withholding periods may apply, preventing use of the animal for a certain period of time after an ear tag impregnated with certain chemicals has been used.

Examples of the invention seek to solve, or at least ameliorate, one or more disadvantages of previous insect repelling ear tags.

### SUMMARY OF THE INVENTION

According to a first aspect of the present invention, there is provided an ear tag for preventing or treating an infection of an eye of an animal, the ear tag comprising a length of material and being arranged to be coupled to an ear of the animal, the length of material being flaccid so as to swing freely about the coupling so that movement of the ear causes the length of material to flap on or near the eye.

Preferably, the length of material is configured to flap on or near the animal's eye so that motion of the material deters insects from the eye.

Preferably, the length of material is configured to contact the eye to dislodge foreign matter or bacteria from the eye.

Preferably, the length of material has a generally uniform thickness about a longitudinal axis of the length of material.

Preferably, the length of material is circular in cross section. Preferably, the length of material is circular in cross section along its entire length. Preferably, the length of material has a substantially constant thickness along its entire length.

Preferably, the length of material is of a length which is sufficient to extend to the eye from the coupling. Preferably, the length of material is of a length which is sufficient so that the length of material comes into contact with the eye. Preferably, the length of material is configured to be freely flexible for generally equal lateral movement.

Preferably, the length of material is dry. Preferably, the length of material is free from insecticide or pesticide.

Preferably, the ear tag is configured to pierce the animal's ear, the ear tag including a first portion configured to pass through the animal's ear and a second portion configured to engage the first portion to attach the ear tag to the animal's ear, the length of material being fixed to either the first or second portions of the ear tag.

Preferably, the ear tag forms an identification tag.

Preferably, the ear tag is arranged to attach to a cow's ear. Preferably, length of material is in the form of a length of string or cord.

According to a second aspect of the present invention, there is provided a method for preventing or treating an infection of an eye of an animal, including the steps of:
coupling an ear tag to an ear of the animal, the ear tag comprising a flaccid length of material; and
arranging the length of material to swing freely about the coupling so that movement of the animal's ear causes the material to flap on or near the eye.

Preferably, the length of material is arranged so that motion of the material deters insects from the eye.

Preferably, the length of material is arranged to contact the eye to dislodge foreign matter or bacteria from the eye.

Preferably, the insect repelling ear tag includes a first portion configured to pass through the animal's ear and a second portion configured to engage the first portion to fasten the ear tag to the animal's ear, the method further including the steps of: piercing the animal's ear to form a hole therein; inserting the first portion through the hole; and fixing the second portion to the first portion to fasten the insect repelling ear tag to the ear of the animal.

Preferably, the method includes the steps of fastening a separate, like ear tag to each ear of the animal. Preferably, the animal is a cow.

### BRIEF DESCRIPTION OF THE DRAWINGS

The invention will be further described, by way of non-limiting example only, with reference to the accompanying drawings in which:

FIG. 1 is a side view of an ear tag of one embodiment of the invention;

FIG. 2 is a side view of the ear tag in another condition of use;

FIG. 3 is a front view of part of the ear tag fitted to the ear of an animal;

FIG. 4 is a side view of another ear tag; and

FIG. 5 is a perspective view of the ear tag of FIG. 4.

### DETAILED DESCRIPTION

With reference to FIG. 1, there is shown an ear tag 10 for preventing or treating an infection of an eye of an animal, the ear tag 10 comprising a length of material 12a, 12b and being arranged to be coupled to an ear of the animal, the length of material 12a, 12b being flaccid so as to swing freely about the coupling so that movement of the ear causes the length of material 12a, 12b to flap on or near the eye.

In the example shown, the length of material 12a, 12b is configured to flap on or near the animal's eye so that motion of the length of material deters insects from the eye. Deterring insects from an animal's eye may prevent the insects landing on the eye and spreading bacteria between animals. The ear tag 10 may deter insects by the length of material 12a, 12b actually contacting the insects, or by the motion of it flapping in the vicinity of the insects.

In other examples, the length of material is configured to contact the eye to dislodge foreign matter or bacteria from the eye. This may prevent an infection caused by foreign matter such as grass seeds becoming lodged in the animal's eye. While it is not intended to be bound to any particular theory, it is believed that contact by the length of material with the eye may dislodge bacteria clinging to the cornea, thereby potentially preventing an infection from occurring or assisting the recovery of an animal suffering from an eye infection.

In the example shown, the length of material 12a, 12b is flaccid so as to be free swinging about the coupling. In this regard, the length of material 12a, 12b is soft or droopy and has flexibility for bending in different directions along its length so that the length of material 12a, 12b is generally not restricted from reaching different parts of the animal's eye due to the shape of the length of material. Advantageously, the length of material 12a, 12b can flap on or near an animal's eye to deter insects or dislodge foreign matter or bacteria from the eye.

The length of material 12a, 12b has a generally uniform thickness about its longitudinal axis, and, in the example shown, the length of material 12a, 12b is circular in cross section and circular in cross section along its entire length. Advantageously, the length of material is freely flexible for movement in all lateral directions and rotation about 360 degrees, enabling the ear tag to flap in response to movement of the animal's ear without being restricted to movement through a particular path, thus enabling the ear tag to flap randomly to deter insects from the eye and to dislodge foreign matter or bacteria from the eye. In this regard, a length of material tapering along its length may also be suitable for use with the ear tag 10. A length of material having other cross sectional shapes, such as a square, pentagon, hexagon, heptagon or octagon, etc, may also be suitable as long as the length of material can swing freely in different directions about its longitudinal axis. In particular, the material is flexible so as to swing freely in different planes which intersect along the length of material, particularly in mutually orthogonal planes. In the example shown, the length of material is configured to be freely flexible for generally equal lateral movement and movement about 360 degrees. In the example shown, the length of material 12a, 12b has a substantially constant thickness along its entire length.

In the example shown, the length of material 12a, 12b is sufficiently long to extend to the eye from the coupling. In the example shown, the length of material 12a, 12b is of a length which is sufficient so that the length of material 12a, 12b, in particular an intermediate portion of the length of material, comes into contact with the eye.

In the example shown, the length of material 12a, 12b is dry and free from insecticide or pesticide. Advantageously, the ear tag is less complex and can be manufactured cheaply without requiring ongoing attention. It may also be much lighter than previously proposed ear tags impregnated with insecticide or pesticide, thus enabling the ear tag to freely flap in response to movement on the animal's ear. Advantageously, as the length of material 12a, 12b is dry and free from insecticide or pesticide, the ear tag may also be used shortly before a cow is due to be milked or slaughtered, thus reducing the inconvenience of milk withholding or meat withholding periods which apply after certain chemicals have been used on an animal.

In one form, the ear tag 10 is attached to the animal's ear by tying the ear tag 10 to the animal's ear, using any suitable common knot, for example. In one form, the ear tag 10 is tied around the animal's ear. In other forms, the ear tag 10 is tied to an existing ear tag of the animal or fed through a hole already formed in the animal's ear.

In the example shown the ear tag 10 includes two lengths of material 12a, 12b, but the ear tag 10 may include only one length of material, or more than two lengths of material. In the example shown, the ear tag 10 is about 330 millimetres long from end to end.

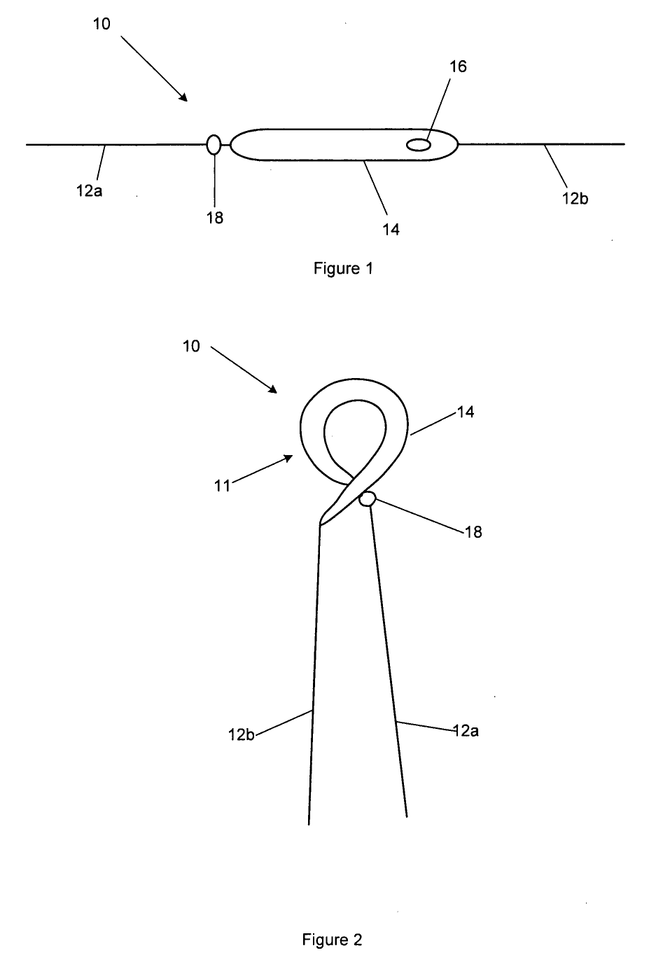

With reference to FIG. 2, the ear tag 10 forms a loop 11 which is attached to the animal's ear. In one form, the loop is drawn tight around the animal's ear. In another form the loop attaches to an existing ear tag of the animal or a hole already formed in the animal's ear.

Ear tag 10 may be attached permanently to an animal's ear when it is young so as to assist in ongoing prevention of eye infections. In this regard, ear tag 10 would remain fitted for the life of an animal. Young animals are more susceptible to eye problems, and fitting an ear tag 10 at the early stage in an animal's life may allow the animal to live generally free from eye infections.

The ear tag 10 includes a body portion 14 having an aperture 16 for receipt of the length of material 12a. The body portion 14 may be made from any suitable commercially available material, such as plastic for example, and may be injection moulded. The body portion 14 may be generally flat or generally circular in cross section.

A securing means 18 is disposed between an end of the length of material 12a and the body portion 14. In the example shown, the securing means 18 is disposed on the length of material 12a, but it may also be provided at other locations, such as at the end of the length of material 12a for example.

The securing means 18, which in the example shown is in the form of a ball, is arranged to engage the aperture 16 of the body portion 14 to form the loop 11. In other forms, the securing means 18 may take any other shape suitable for engaging the aperture 16.

In one form, the length of material 12a is arranged to be fed through the aperture 16 in the body portion 14 to bring the securing means 18 into engagement with the aperture 16 to form the loop 11. In another form, the securing means 18 is arranged to be received in the aperture 16 to form the loop 11. The securing means may, for example, be a series of successive barbs arranged around the loop to engage the aperture and form a ratchet type arrangement which permits movement in only one direction to facilitate tightening/locking of the loop.

The cross sectional size of the securing means 18 is greater than a dimension of the aperture 16 in the body portion 14 so that the body portion 14 is required to elastically deform to allow the securing means 18 to pass through the aperture 16 so that withdrawal of the securing means 18 from the aperture 16 is resisted.

In the embodiment shown, the body portion 14 is disposed between a first length of material 12a and a second length of material 12b, each of which extends from an end of the body portion 14.

It is common for farm animals to have ear tags for identification purposes. In one form, the ear tag 10 can be arranged to be attached to the animal's ear by attachment to an existing ear tag fitted to the animal's ear. In another form, an identification tag may be incorporated into the ear tag 10.

In one form, the length of material 12a, 12b is in the form of a length of string or cord. In other forms, the length of material may be rubber, nylon, wool, leather or fibre.

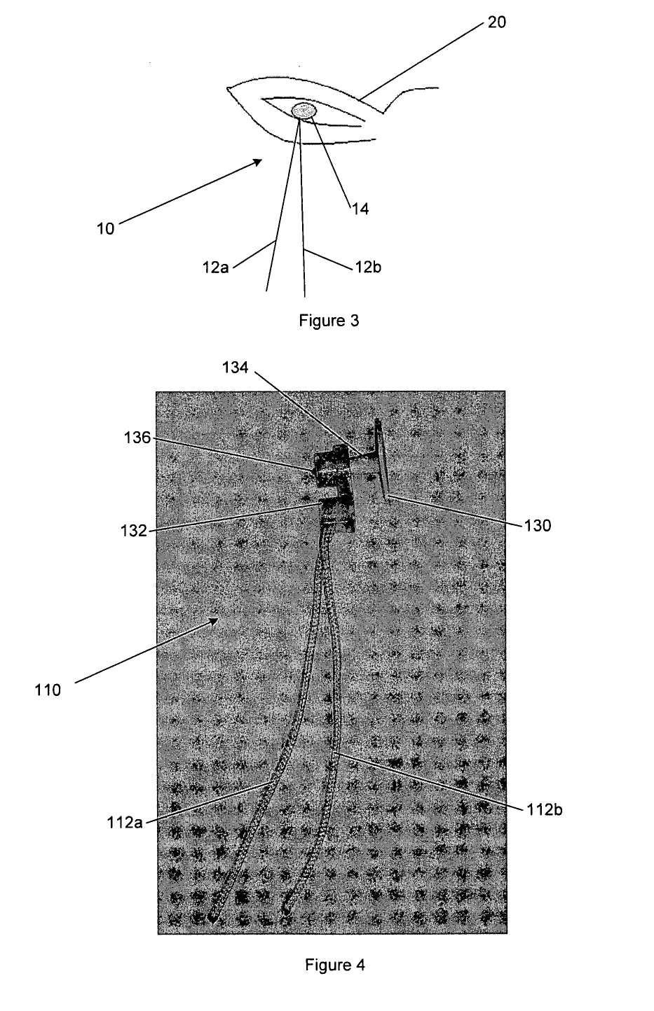

With reference to FIG. 3, the ear tag is shown attached to a cow's ear 20 by tying the ear tag to an ear tag previously fitted to the cow's ear. In other forms, the ear tag may be fitted to an ear of different animals.

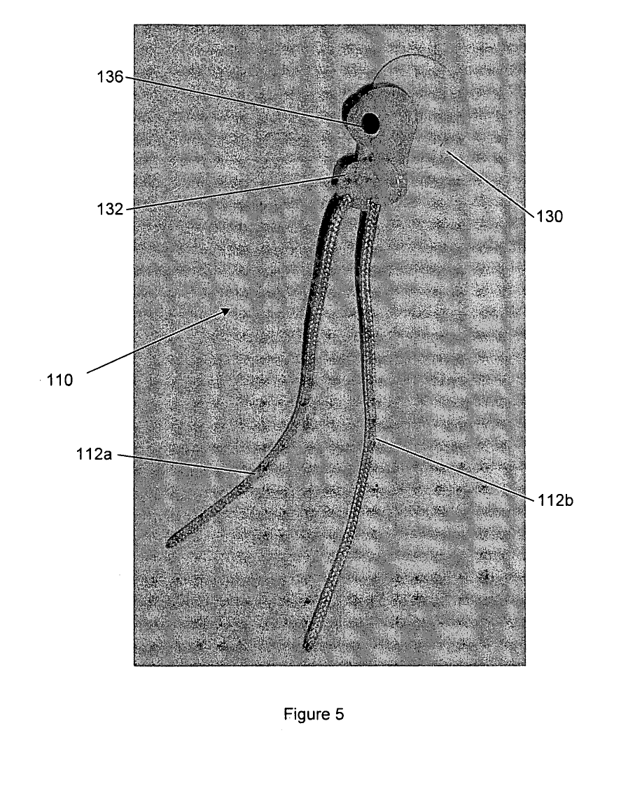

With reference to FIGS. 4 and 5, there is shown another ear tag 110 for preventing or treating an infection of an eye of an animal. The ear tag 110 comprises a length of material 112a, 112b and is arranged to be coupled to an ear of the animal, the length of material 112a, 112b being flaccid so as to swing freely about the coupling so that movement of the ear causes the length of material to flap on or near the eye.

In the example shown, the length of material 112a, 112b is configured to flap on or near the animal's eye so that motion of the length of material 112a, 112b deters insects from the eye. Deterring insects from an animal's eye may prevent the insects landing on the eye and spreading bacteria between animals. The ear tag 110 may deter insects by the length of material 112a, 112b actually contacting the insects, or by the motion of it flapping in the vicinity of the insects.

In other examples, the length of material 112a, 112b is configured to contact the eye to dislodge foreign matter or bacteria from the eye. This may prevent an infection caused by foreign matter such as grass seeds becoming lodged in the animal's eye. While it is not intended to be bound to any particular theory, it is believed that contact by the length of material with the eye may dislodge bacteria clinging to the cornea, thereby potentially preventing an infection from occurring or assisting the recovery of an animal suffering from an eye infection.

In the example shown, the length of material 112a, 112b is flaccid so as to be free swinging about the coupling. In this regard, the length of material 112a, 112b is soft or droopy and has flexibility for bending in different directions along its length so that the length of material 112a, 112b is generally not restricted from reaching different parts of the animal's eye due to the shape of the length of material. Advantageously, the length of material 112a, 112b can flap on or near an animal's eye to deter insects or dislodge foreign matter or bacteria from the eye.

The length of material 112a, 112b has a generally uniform thickness about its longitudinal axis, and, in the example shown, the length of material 112a, 112b is circular in cross section and circular in cross section along its entire length. Advantageously, the length of material is freely flexible for movement in all lateral directions and rotation about 360 degrees, enabling the ear tag to flap in response to movement of the animal's ear without being restricted to movement through a particular path, thus enabling the ear tag to flap randomly to deter insects from the eye and to dislodge foreign matter or bacteria from the eye. In this regard, a length of material tapering along its length may also be suitable for use with the ear tag 110. A length of material having other cross sectional shapes, such as a square, pentagon, hexagon, heptagon or octagon, etc, may also be suitable as long as the length of material can swing freely in different directions about its longitudinal axis. In particular, the material is flexible so as to swing freely in different planes which intersect along the length of material, particularly in mutually orthogonal planes. In the example shown, the length of material is configured to be freely flexible for generally equal lateral movement and movement about 360 degrees. In the example shown, the length of material 112a, 112b has a substantially constant thickness along its entire length.

In the example shown, the length of material 112a, 112b is sufficiently long to extend to the eye from the coupling. In the example shown, the length of material 112a, 112b is of a length which is sufficient so that the length of material 112a, 112b, in particular an intermediate portion of the length of material, comes into contact with the eye.

In the example shown, the length of material 112a, 112b is dry and free from insecticide or pesticide. Advantageously, the ear tag is less complex and can be manufactured cheaply without requiring ongoing attention. It may also be much lighter than previously proposed ear tags impregnated with insecticide or pesticide, thus enabling the ear tag to freely flap in response to movement on the animal's ear. Advantageously, as the length of material 112a, 112b is dry and free from insecticide or pesticide, the ear tag may also be used shortly before a cow is due to be milked or slaughtered, thus reducing the inconvenience of milk withholding or meat withholding periods which apply after certain chemicals have been used on an animal.

In the example shown the ear tag 110 includes two lengths of material 112a, 112b, but the ear tag 110 may include only one length of material, or more than two lengths of material. In the example shown, each length of material 112a, 112b is about 140 millimetres long.

In the example shown, the ear tag 110 is configured to pierce the animal's ear. The ear tag 110 includes a first portion 130 configured to pass through the animal's ear and a second portion 132 configured to engage the first portion 130 to fixedly attach the ear tag 110 to the animal's ear. In the example shown, the length of material 112a, 112b is fixed to the second portion 132, but may be fixed to either the first or second portions 130, 132 of the ear tag 110. The ear tag 110 is attached to the animal's ear using a conventional ear tagger tool.

In the example shown, the first portion 130 is configured to be in the form of a conventional button having identification markings so that the ear tag 110 forms an identification tag.

Ear tag 110 may be attached permanently to an animal's ear when it is young so as to assist in ongoing prevention of eye infections. In this regard, ear tag 110 would remain fitted for the life of an animal. Young animals are more susceptible to eye problems, and fitting an ear tag 110 at the early stage in an animal's life may allow the animal to live generally free from eye infections.

The first and second portions 130, 132 of the ear tag 110 may be made from any suitable commercially available material, such as a plastic material for example, and may be injection moulded.

In the example shown, the second portion 132 is in the form of a housing which is configured on one part to receive a protrusion 134 of the first portion 130, the protrusion 134 having a bulbous end 136, and on a second part to receive the length of material 112a, 112b. The second portion 132 is suitably flexible to allow receipt of the bulbous end 136 through an aperture formed in the second portion 132 and suitably resilient so as to prevent withdrawal of the bulbous end 136 through the aperture. The second portion 132 is also configured so that the length of material 112a, 112b can be fixed thereto once it has been received by the second portion 132.

In one form, the length of material 112a, 112b is in the form of a length of string. In other forms, the length of material may be rubber, nylon, wool, leather or fibre.

In one example, a method for preventing or treating an infection of an eye of an animal is provided, the method including the steps of: coupling an ear tag 10, 110 to an ear of the animal, the ear tag 10, 110 comprising a length of flaccid material 12a, 12b, 112a, 112b; and arranging the length of material 12a, 12b, 112a, 112b to swing freely about the coupling so that movement of the animal's ear causes the length of material to flap near the eye.

In one example, the length of material 12a, 12b, 112a, 112b is arranged so that motion of the length material 12a, 12b, 112a, 112b deters insects from the eye. The ear tag 10, 110 may deter insects by the length of material 12a, 12b, 112a, 112b actually contacting the insects, or by the motion of it flapping in the vicinity of the insects. In another example, the length of material 12a, 12b, 112a, 112b is arranged to contact the eye to dislodge foreign matter or bacteria from the eye.

In one form, the ear tag 10 is attached to the animal's ear by tying the ear tag 10 to the animal's ear, using any suitable common knot, for example. In one form, the ear tag 10 is tied around the animal's ear. In other forms, the ear tag 10 is tied to an existing ear tag of the animal or fed through a hole already formed in the animal's ear.

In one example, the method further includes the step of manipulating the length of material 12a,12b to form a loop 11 which is fixedly attached to the animal's ear. The length of material may be manipulated by tying the length of material to the animal's ear.

In one form, the loop is drawn tight around the animal's ear. In another form the loop attaches to an existing ear tag of the animal or a hole already formed in the animal's ear.

In one example, the insect repelling ear tag 10 includes a body portion 14 and a securing means 18, and the method includes the steps of forming the loop 11 by feeding an end of the length of material 12a,12b through an aperture 16 in the body portion 14 to bring the securing means 18 into engagement with the aperture 16.

In another example, the insect repelling ear tag 110 includes a first portion 130 configured to pass through the animal's ear and a second portion 132 configured to engage the first portion 130 to fasten the ear tag 110 to the animal's ear. The method further includes the steps of piercing the animal's ear to form a hole therein, inserting the first portion 130 through the hole and fixing the second portion 132 to the first portion 130 to attach the insect repelling ear tag 110 to the ear of the animal.

In one example, the method includes the steps of fastening a separate, like insect repelling ear tag 10 to each ear of the animal. With reference to FIG. 3, the ear tag is shown attached to a cow's ear 20 by tying the ear tag to an ear tag previously fitted to the cow's ear. In other examples, the ear tag may be fitted to an ear of different animals.

The embodiments have been described by way of example only and modifications are possible within the scope of the invention disclosed. For example, embodiments of the invention may be used to treat other ocular diseases or conditions not mentioned, or used for more than one purpose, for example the ear tag may be incorporated into a cattle identification ear tag.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1.-22. (canceled)

23. An ear tag for preventing or treating an infection of an eye of an animal, the ear tag comprising a length of material and being arranged to be coupled to an ear of the animal, the length of material being flaccid so as to swing freely about the coupling so that movement of the ear causes the length of material to flap on or near the eye.

24. An ear tag as claimed in claim 23, wherein the length of material is configured to flap on or near the animal's eye so that motion of the length of material deters insects from the eye.

25. An ear tag as claimed in claim 23, wherein the length of material is configured to contact the eye to dislodge foreign matter or bacteria from the eye.

26. An ear tag as claimed in claim 23, wherein the length of material has a generally uniform thickness about a longitudinal axis of the length of material.

27. An ear tag as claimed in claim 23, wherein the length of material is circular in cross section; optionally wherein the length of material is circular in cross section along its entire length.

28. An ear tag as claimed in claim 23, wherein the length of material has a substantially constant thickness along its entire length.

29. An ear tag as claimed in claim 23, wherein the length of material is of a length which is sufficient to extend to the eye from the coupling.

30. An ear tag as claimed in claim 23, wherein the length of material is of a length which is sufficient so that the length of material comes into contact with the eye.

31. An ear tag as claimed claim 23, wherein the length of material is configured to be freely flexible for generally equal lateral movement.

32. An ear tag as claimed in claim 23, wherein the length of material is dry.

33. An ear tag as claimed in claim 23, wherein the length of material is free from insecticide or pesticide.

34. An ear tag as claimed in claim 23, wherein the ear tag is configured to pierce the animal's ear, the ear tag including a first portion configured to pass through the animal's ear and a second portion configured to engage the first portion to attach the ear tag to the animal's ear, the length of material being fixed to either the first or second portions of the ear tag.

35. An ear tag as claimed in claim 23, wherein the ear tag forms an identification tag.

36. An ear tag as claimed in any claim 23, wherein the ear tag is arranged to attach to a cow's ear.

37. An ear tag as claimed in claim 23, wherein the length of material is in the form of a length of string or cord.

38. A method for preventing or treating an infection of an eye of an animal, including the steps of:
coupling an ear tag to an ear of the animal, the ear tag comprising a flaccid length of material; and
arranging the length of material to swing freely about the coupling so that movement of the animal's ear causes the length of material to flap on or near the eye.

39. A method as claimed in claim 38, wherein the length of material is arranged so that motion of the length of material deters insects from the eye, optionally wherein the length of material is arranged to contact the eye to dislodge foreign matter or bacteria from the eye.

40. A method as claimed in any claim 38, wherein the ear tag includes a first portion configured to pass through the animal's ear and a second portion configured to engage the first portion to fasten the ear tag to the animal's ear, the method further including the steps of:
piercing the animal's ear to form a hole therein;
inserting the first portion through the hole; and
fixing the second portion to the first portion to fasten the ear tag to the ear of the animal.

41. A method as claimed in claim 38, including the steps of fastening a separate, like insect repelling ear tag to each ear of the animal.

42. A method as claimed in claim 38, wherein the animal is a cow.
